(19) United States
(12) Patent Application Publication
(10) Pub. No.: US 2014/0043190 A1
(43) Pub. Date: Feb. 13, 2014

(54) PLANAR INVERTED F ANTENNA STRUCTURE

(71) Applicants: Krishna Prasad VUMMIDI MURALI, San Jose, CA (US); Ponnappa PASURA, Hillsboro, OR (US)

(72) Inventors: Krishna Prasad VUMMIDI MURALI, San Jose, CA (US); Ponnappa PASURA, Hillsboro, OR (US)

(73) Assignee: SUMMIT SEMICONDUCTOR LLC, Hillsboro, OR (US)

(21) Appl. No.: 13/572,500

(22) Filed: Aug. 10, 2012

(51) Int. Cl. H01Q 9/04; H01P 11/00

(52) U.S. Cl. 343/700 MS; 29/600

(57) ABSTRACT

A planar inverted F antenna structure includes an insulating substrate having a main face, a ground plane conductor on the main face of the substrate, the ground plane conductor having a straight edge, and an antenna element on the main face of the substrate. The antenna element includes a feed portion, a ground return portion, and a radiative arm projecting from the feed portion and extending beside the straight edge of the ground plane conductor. A first edge of the antenna arm is a straight edge that is located between a second edge of the antenna arm and the straight edge of the ground plane conductor and is spaced from the straight edge of the ground plane conductor. The first edge of the antenna arm is inclined to the straight edge of the ground plane conductor.

### BACKGROUND OF THE INVENTION

The subject matter of this application relates to a planar inverted F antenna (PIFA) structure.

A PIFA structure may be formed on a circuit board or other insulating substrate and comprises a feed that is connected at one side to a transmission line that provides an electrical signal for driving the antenna and an antenna arm that extends alongside an edge of a ground plane conductor. An opposite side of the feed is connected to the ground plane conductor through a ground return path.

Performance of the planar inverted F antenna structure depends on several factors. In some configurations, the length of the antenna arm from the ground return to the distal end of the arm should be approximately one-quarter the wavelength of the signal to be radiated. The distributed capacitance between the arm and the ground plane should be related to the inductance of the ground return path so that the impedance of the antenna matches the characteristic impedance of the transmission line used to drive the antenna. The space available for the antenna arm on a circuit board may be limited, making it difficult to obtain the desired balance between the length of the antenna arm and the capacitance between the arm and the ground plane conductor.

In operation, the current in the antenna arm is at a minimum at the distal end of the arm and is at a maximum at the proximal end of the arm.

### SUMMARY OF THE INVENTION

In accordance with a first aspect of the subject matter of this application there is provided a planar inverted F antenna structure comprising an insulating substrate having a main face, a ground plane conductor on the main face of the substrate, the ground plane conductor having a straight edge, and an antenna element on the main face of the substrate, the antenna element including a feed portion, a ground return portion, and a radiative arm projecting from the feed portion and extending beside said straight edge of the ground plane conductor, the antenna arm having a proximal end nearer the feed portion and a distal end farther from the feed portion and being bounded by first and second opposite edges each extending from the proximal end to the distal end, wherein the first edge is a straight edge that is located between the second edge of the antenna arm and the straight edge of the ground plane conductor and is spaced from the straight edge of the ground plane conductor, and the first edge of the antenna arm is inclined to the straight edge of the ground plane conductor such that the spacing of the first edge of the antenna arm from said straight edge of the ground plane conductor increases as distance along the antenna arm from the proximal end to the distal end increases.

In accordance with a second aspect of the subject matter of this application there is provided a method of manufacturing an inverted F antenna structure that includes an insulating substrate having a main face, a ground plane conductor on the main face of the substrate, the ground plane conductor having a straight edge, and an antenna element on the main face of the substrate, the antenna element including a feed portion for connection to a transmission line for driving the antenna, a ground return portion, and a radiative arm projecting from the feed portion and extending beside said straight edge of the ground plane conductor, the antenna arm having a proximal end nearer the feed portion and a distal end farther from the feed portion and being bounded by first and second opposite edges, wherein the first edge is a straight edge that is located between the second edge of the antenna arm and the straight edge of the ground plane conductor and is spaced from the straight edge of the ground plane conductor, said method comprising designing the antenna by assigning a length to the first edge of antenna arm based on wavelength of an electromagnetic signal to be radiated by the antenna and assigning an inclination of the first edge of the antenna arm to the straight edge of the ground plane conductor such that capacitance between the antenna arm and the ground plane conductor and inductance of the ground return portion are so related that the antenna structure has an impedance that matches the characteristic impedance of the transmission line, and fabricating the antenna structure in accordance with the design.

### BRIEF DESCRIPTION OF THE DRAWINGS

For a better understanding of the invention, and to show how the same may be carried into effect, reference will now be made, by way of example, to the accompanying drawings, in which:

FIG. 1 is a partly broken away plan view of a circuit board on which four planar inverted F antenna structures designed to operate at 5.5 GHz fed by a coplanar waveguide transmission line having a characteristic impedance of 50 ohm are formed, and

FIG. 2 is an enlarged plan view of one of the PIFA structures.

### DETAILED DESCRIPTION

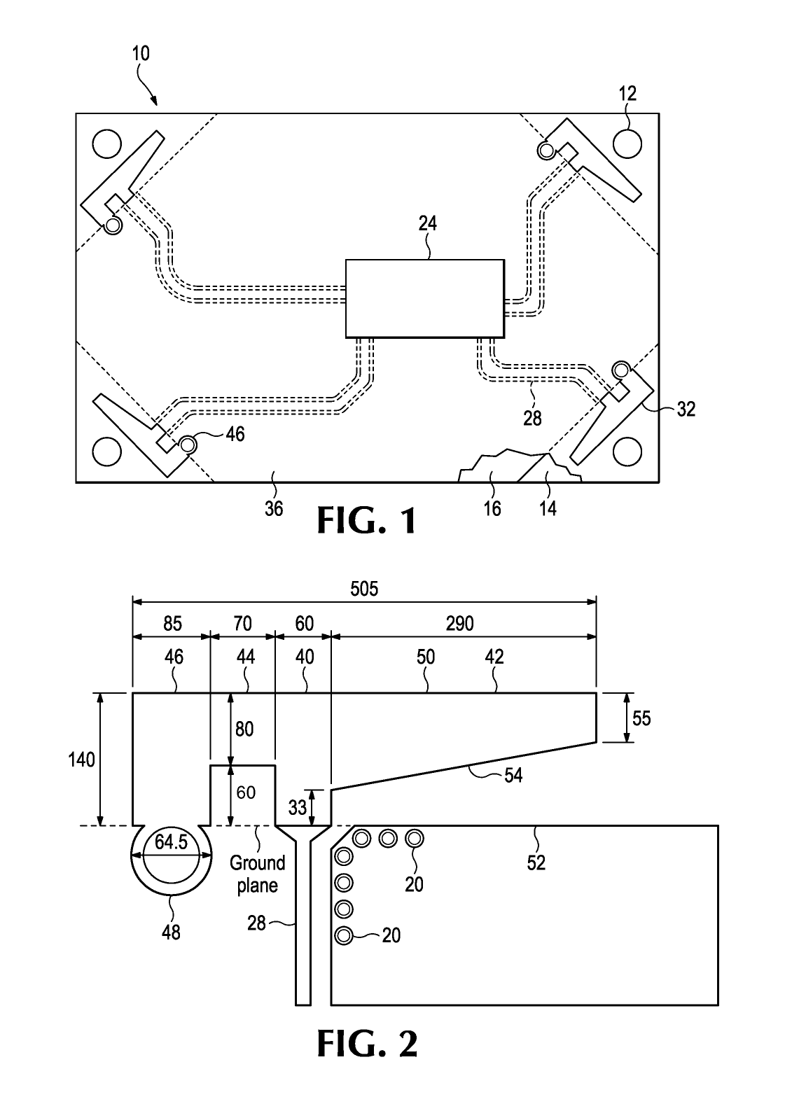

Referring to FIG. 1, the circuit board 10 is rectangular and is formed at each corner with a hole 12 for receiving a fastening or locating element (not shown) for positioning the circuit board relative to other components of the system in which the board is used. The circuit board comprises a substrate 14 having a dielectric constant of about 4.3. The circuit board has upper and lower surfaces on each of which a blanket conductive layer has been formed and selectively etched to provide ground plane conductors 16 on both the upper surface and the lower surface of the circuit board. The ground plane conductors 16 are connected together by numerous vias 20 (FIG. 2), only a few of which are shown, providing good electrical connection between the two ground plane conductors. Various integrated circuit components are attached to each side of the circuit board. The circuit components that are attached to the upper surface of the circuit board include RF switches, baluns and radios, designated generally as a circuit block 24. During fabrication of the upper ground plane conductor, parts of the upper conductive layer are etched away to provide coplanar wave guide transmission lines 28 connecting outputs of the circuit block 24 to four antenna structures 32 respectively. The circuit board substrate has a coating 36 of electrically insulating material covering substantially the entire upper surface of the circuit board except for the antenna structures, which are gold plated.

Due to various design constraints, the upper ground plane conductor covers most of the top surface of the circuit board, leaving a small triangular area in each corner for the four antenna structures 32 respectively. The presence of the mounting holes 12 limits the space available for the antenna structures.

Referring now to FIG. 2, each antenna structure has four distinct portions. The feed 40 is a rectangular portion constituting an extension of the transmission line that drives the antenna. An antenna arm 42 projects from one side of the feed 40 and a lift portion 44 projects from the opposite side and is connected to a lateral portion 46. The dimensions of the arm (in mils) are marked in FIG. 2 and provide acceptable tuning over a frequency range from 5.1 GHz to 5.8 GHz. The different portions of the antenna structure are formed when the upper conductive layer is etched and accordingly the lateral portion is electrically connected to the upper ground conductor. The lateral portion 46 is also connected to the lower ground conductor by a ground via 48. The lift portion and the lateral portion together form a ground return for the antenna structure.

In the case of the antenna configuration shown in FIG. 2, most of the current is concentrated during operation in the arm 42 and consequently the length of the arm from the point of feed of the antenna is the dominant factor in determining the operating frequency of the antenna.

It will be seen from FIG. 2 that the antenna arm has a proximal end at which it is connected to the feed and a distal end spaced from the feed, and also has first and second edges, both of which are straight. The second edge 50 is parallel to the adjacent edge 52 of the upper ground plane conductor whereas the first edge 54 is inclined to the edge 52 of the ground plane conductor such that these edges diverge away from the proximal end of the arm. The inclination between the inner edge of the arm and the edge of the ground plane conductor allows the distributed capacitance (and hence the input impedance) between the arm and the ground plane conductor to be selected independently of the length of the arm.

Selection of the dimensions of a PIFA structure involves tradeoffs among numerous variables. Consider the problem of designing a PIFA structure similar to that shown in FIG. 2 but with the arm at a fixed, uniform distance from the ground plane conductor. In this case, the capacitance between the arm and the ground plane conductor would vary directly with the length of the arm and inversely with the distance between the arm and the ground plane conductor. Thus, should it be necessary to change the capacitance between the arm and the ground plane in order to match the impedance of the transmission line without changing the distance of the arm from the ground plane conductor, it would be necessary change the length of the arm, which would result in a change in the center frequency of radiation. Changing the distance of the arm from the ground plane conductor will generally change the width of the arm, between the first and second edges. This may affect the radiation resistance of the antenna, and the resistance of the arm particularly at the proximal end of the arm, where the current is a maximum, and affect the performance of the antenna structure.

By designing the antenna structure so that the inner edge of the arm is inclined to the edge of the ground plane conductor, the capacitance between the arm and the ground plane conductor can be varied by varying the inclination without substantially affecting the length of the arm or the resistance of the arm in the vicinity of the proximal end of the arm.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A planar inverted F antenna structure comprising:
an insulating substrate having a main face,
a ground plane conductor on the main face of the substrate, the ground plane conductor having a straight edge, and
an antenna element on the main face of the substrate, the antenna element including a feed portion, a ground return portion, and a radiative arm projecting from the feed portion and extending beside said straight edge of the ground plane conductor, the antenna arm having a proximal end nearer the feed portion and a distal end farther from the feed portion and being bounded by first and second opposite edges each extending from the proximal end to the distal end,
wherein the first edge is a straight edge that is located between the second edge of the antenna arm and the straight edge of the ground plane conductor and is spaced from the straight edge of the ground plane conductor,
and the first edge of the antenna arm is inclined to the straight edge of the ground plane conductor such that the spacing of the first edge of the antenna arm from said straight edge of the ground plane conductor increases as distance along the antenna arm from the proximal end to the distal end increases.

2. An antenna structure according to claim 1, wherein the second edge of the radiative antenna arm is straight and is substantially parallel to the straight edge of the ground plane conductor, whereby the spacing of the second edge of the antenna arm from the first edge of the antenna arm decreases as distance along the antenna arm from the proximal end to the distal end increases.

3. A method of manufacturing an inverted F antenna structure that includes an insulating substrate having a main face, a ground plane conductor on the main face of the substrate, the ground plane conductor having a straight edge, and an antenna element on the main face of the substrate, the antenna element including a feed portion for connection to a transmission line for driving the antenna, a ground return portion, and a radiative arm projecting from the feed portion and extending beside said straight edge of the ground plane conductor, the antenna arm having a proximal end nearer the feed portion and a distal end farther from the feed portion and being bounded by first and second opposite edges, wherein the first edge is a straight edge that is located between the second edge of the antenna arm and the straight edge of the ground plane conductor and is spaced from the straight edge of the ground plane conductor, said method comprising:
designing the antenna by assigning a length to the first edge of antenna arm based on wavelength of an electromagnetic signal to be radiated by the antenna and assigning an inclination of the first edge of the antenna arm to the straight edge of the ground plane conductor such that capacitance between the antenna arm and the ground plane conductor and inductance of the ground return portion are so related that the antenna structure has an impedance that matches the characteristic impedance of the transmission line, and
fabricating the antenna structure in accordance with the design.
